(19) United States
(12) Patent Application Publication
(10) Pub. No.: US 2020/0373633 A1
(43) Pub. Date: Nov. 26, 2020

(54) COOLING DEVICE FOR VEHICLE BATTERY

(71) Applicants: Hyundai Motor Company, Seoul (KR); Kia Motors Corporation, Seoul (KR)

(72) Inventors: Yong Jae Kim, Suwon-si (KR); Jeong Hun Seo, Suwon-si (KR); Sang Wan Kim, Busan (KR); Jin Won Kim, Pyeongtaek-si (KR); Yong Jin Lee, Hwaseong-si (KR); Jun Seok Choi, Hwaseong-si (KR)

(73) Assignees: Hyundai Motor Company, Seoul (KR); Kia Motors Corporation, Seoul (KR)

(21) Appl. No.: 16/661,924

(22) Filed: Oct. 23, 2019

(30) Foreign Application Priority Data
May 23, 2019 (KR) 10-2019-0060618

(51) Int. Cl. H01M 10/613; H01M 10/625; H01M 10/6551; H01M 10/6556; H01M 2/10

(52) U.S. Cl. CPC H01M 10/613; H01M 10/625; B60L 58/26; H01M 10/6556; H01M 2/1077; H01M 10/6551

(57) ABSTRACT

A cooling device for a vehicle battery may include a cooling fin receiving heat generated by a plurality of battery cells and discharging the heat to an outside, and a bendable heat-transfer body receiving heat from the cooling fin, the bendable heat-transfer body being composed of a bimetal so that the bimetal is spaced from a vehicle body panel when the temperature decreases and such that the bimetal is bent to be brought into contact with the vehicle body panel when the temperature increases.

### CROSS-REFERENCE TO RELATED APPLICATION

The present application claims priority to Korean Patent Application No. 10-2019-0060618, filed on May 23, 2019, the entire contents of which is incorporated herein for all purposes by this reference.

### BACKGROUND OF THE INVENTION

### Field of the Invention

The present invention relates to a cooling device for a vehicle battery, and more particularly to a passive cooling system.

### Description of Related Art

To improve fuel efficiency and regulate CO₂ emissions, eco-friendly vehicles, to which a battery is mounted, are being actively developed on a global scale.

Owing to the popularization of eco-friendly vehicles, a reduction in the cost of a battery system, which occupies the greater portion of the manufacturing cost of such a vehicle, has been receiving increasing emphasis. To reduce the cost of a battery system, research on a non-cooling system or a passive cooling system is being actively conducted.

In conventional passive cooling systems, a technology for cooling a battery by employing a natural convection phenomenon by a heat sink mounted on the battery is chiefly used. In the instant case, there are, however, disadvantages in that the battery is excessively cooled at low temperatures and cooling performance deteriorates at high temperatures.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a cooling device configured for a vehicle battery, which is configured to cool the battery without consuming power and to achieve minimization of cooling performance at a low temperature and enhancement of cooling performance at a high temperature, whereby it is possible to efficiently cool the vehicle battery at a low cost.

In accordance with an aspect of the present invention, the above and other objects may be accomplished by the provision of a cooling device configured for a vehicle battery including a cooling fin receiving heat generated by a plurality of battery cells and discharging the heat to an outside, and a bendable heat-transfer body receiving heat from the cooling fin, the bendable heat-transfer body being composed of a bimetal so that the bimetal is spaced from a vehicle body panel when the temperature decreases and such that the bimetal is bent to be brought into contact with the vehicle body panel when the temperature increases.

The bendable heat-transfer body may be constructed such that both end portions thereof are secured to the cooling fin and the intermediate portion thereof is brought into contact with the vehicle body panel when the bendable heat-transfer body is deformed by heat transferred from the cooling fin.

In accordance with another aspect of the present invention, there is provided a cooling device configured for a vehicle battery including a cooling fin receiving heat generated by a plurality of battery cells and discharging the heat to an outside, a vehicle body panel provided in a vehicle, an extensible heat-transfer body receiving heat from the cooling fin, wherein a length of the extensible heat-transfer body is increased when the temperature increases and is decreased in length when the temperature decreases, and a restriction unit of supporting the extensible heat-transfer body to increase the area in which the extensible heat-transfer body comes into contact with the cooling fin and the vehicle body panel when the length of the extensible heat-transfer body is increased due to the heat transferred from the cooling fin.

The restriction unit may include support blocks, which are mounted between the cooling fin and the vehicle body panel to maintain a predetermined distance between the cooling fin and the vehicle body panel and to which both end portions of the extensible heat-transfer body are secured.

The extensible heat-transfer body may be secured at both end portions thereof between the cooling fin and the support blocks.

The extensible heat-transfer body may be configured to have a corrugated shape, which extends in a longitudinal direction between the cooling fin and the vehicle body panel in a zig-zag manner.

The extensible heat-transfer body may be constructed such that a contact area between the cooling fin and the vehicle body panel is reduced at a relatively low temperature and such that the contact area between the cooling fin and the vehicle body panel is increased at relatively high temperatures.

The extensible heat-transfer body may be repeatedly bent in one direction three times and then in an opposite direction three times to define the corrugated shape, and each of the bent portions of the extensible heat-transfer body may be bent at a blunt angle.

The support blocks may be made of wood or ceramic.

In accordance with a further aspect of the present invention, there is provided a cooling device configured for a vehicle battery including a module pack case, which surrounds a plurality of battery cells to receive heat generated by the battery cells and to discharge the heat to an outside, an extensible heat-transfer body receiving the heat from the module pack case, a length of which is increased when the temperature increases and is decreased in length when the temperature decreases, and a restriction unit of supporting the extensible heat-transfer body to increase the area over which the extensible heat-transfer body comes into contact with the module pack case and the vehicle body panel when the length of the extensible heat-transfer body is increased due to the heat transferred from the module pack case.

The restriction unit may include support blocks, which are mounted between the cooling fin and the vehicle body panel to maintain a predetermined distance between the cooling fin and the vehicle body panel and to which both end portions of the extensible heat-transfer body are secured, and fastening bolts for fastening both end portions of the module pack case and both end portions of the extensible heat-transfer body to the support blocks.

The extensible heat-transfer body may be secured at both end portions thereof between the module pack case and the support blocks and may be configured to have a corrugated shape, which extends in a longitudinal direction between the module pack case and the vehicle body panel in a zig-zag manner.

The extensible heat-transfer body may be repeatedly bent in one direction three times and then in an opposite direction three times to define the corrugated shape, and each of the bent portions of the extensible heat-transfer body may be bent at a blunt angle.

The bimetal may include any one of an iron-nickel alloy and iron, which is a metal having a relatively high coefficient of thermal expansion, and any one of nickel-chrome-iron alloy, copper-zinc alloy and copper, which is a metal having a relatively low coefficient of thermal expansion, the two metals being layered and integrally formed with each other.

The extensible heat-transfer body may include any one of aluminum, iron-nickel alloy, iron, zinc and silver.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a cooling device configured for a vehicle battery according to various exemplary embodiments of the present invention when a temperature of the battery is relatively low;

FIG. 2 is a view exemplarily illustrating the cooling device configured for a vehicle battery according to the various exemplary embodiments of the present invention when a temperature of the battery is relatively high;

FIG. 3 is a view exemplarily illustrating a cooling device configured for a vehicle battery according to various exemplary embodiments of the present invention when a temperature of the battery is relatively low;

FIG. 4 is a view exemplarily illustrating the cooling device configured for a vehicle battery according to the various exemplary embodiments of the present invention when a temperature of the battery is relatively high;

FIG. 5 is a view exemplarily illustrating a cooling device configured for a vehicle battery according to various exemplary embodiments of the present invention when a temperature of the battery is relatively low; and

FIG. 6 is a view exemplarily illustrating the cooling device configured for a vehicle battery according to the various exemplary embodiments of the present invention when a temperature of the battery is relatively high.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Reference will now be made in detail to the exemplary embodiments of the present invention, examples of which are illustrated in the accompanying drawings.

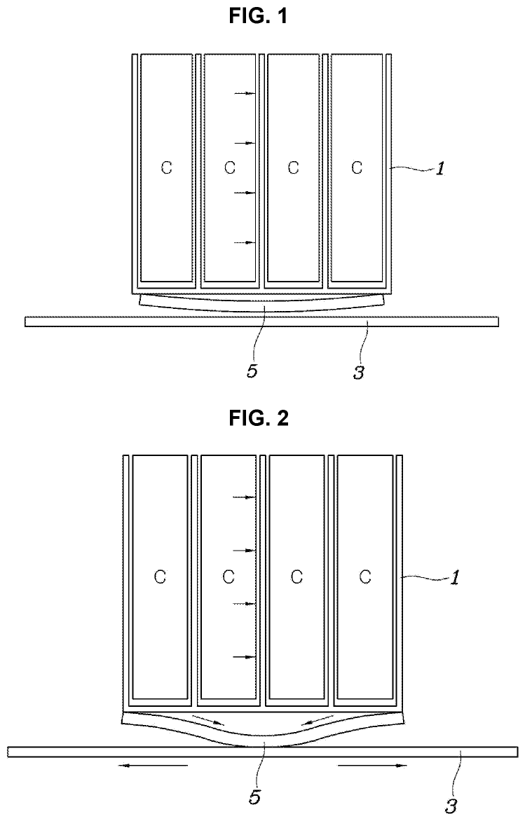

Referring to FIG. 1 and FIG. 2, a cooling device configured for a vehicle battery according to various exemplary embodiments of the present invention includes a cooling fin 1 configured to receive heat generated by a plurality of battery cells C and to discharge the heat to the outside, a vehicle body panel 3, and a bendable heat-transfer body 5 configured to receive the heat from the cooling fin 1, which is composed of a bimetal so that the bimetal is spaced from the vehicle body panel 3 when the temperature decreases and such that the bimetal is bent to be brought into contact with the vehicle body panel 3 when the temperature increases.

In other words, when the temperature of the battery cells C decreases and thus the bendable heat-transfer body 5, which is composed of the bimetal, is spaced from the vehicle body panel 3, the battery cells C are cooled only by the radiation performance of the cooling fin 1 itself. Meanwhile, when the bendable heat-transfer body 5 is deformed due to an increase in the temperature thereof and the bendable heat-transfer body 5 thus is configured as a heat conductor for directly connecting the cooling fin 1 to the vehicle body panel 3, the heat generated by the battery is transferred to the vehicle body panel 3 through the cooling fin 1 and the bendable heat-transfer body 5, realizing relatively high cooling performance.

In the exemplary embodiment of the present invention, the bendable heat-transfer body 5 is constructed such that both end portions thereof are secured to the cooling fin 1 and the intermediate portion thereof is brought into contact with the vehicle body panel 3 when the bendable heat-transfer body 5 is deformed due to the heat transferred from the cooling fin 1.

Accordingly, when the bendable heat-transfer body 5 is not sufficiently heated, the vehicle body panel 3 is spaced from the cooling fin 1 and the bendable heat-transfer body 5 and thus the cooling performance of the battery in the cooling fin 1 is relatively low, as illustrated in FIG. 1. Meanwhile, when the bendable heat-transfer body 5 comes into contact with the vehicle body panel 3, it is possible to remove the heat of the battery with higher cooling performance, as illustrated in FIG. 2.

Since the control of the cooling performance in consideration of the temperature of the battery cells does not consume additional energy and does not require active control, it is possible to reduce the cost of the vehicle and to reliably provide discriminatory cooling performance which is more efficient in a high-temperature condition than in a low-temperature condition of the battery cells C.

For reference, the bimetal may be composed of iron-nickel alloy, iron or the like, which is a metal having a relatively high coefficient of thermal expansion, and nickel-chrome-iron alloy, copper-zinc alloy, copper or the like, which is a metal having a relatively low coefficient of thermal expansion, the two metals being layered and integrally formed with each other.

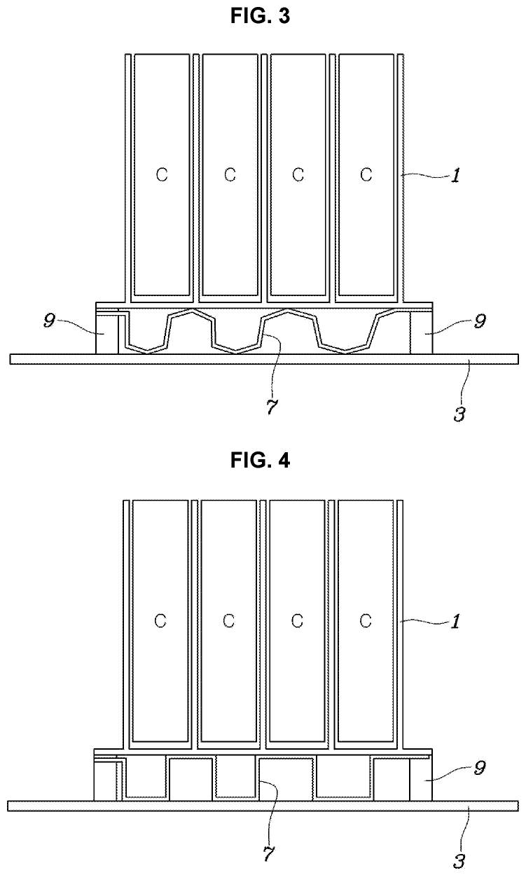

FIG. 3 and FIG. 4 are views illustrating a cooling device configured for a vehicle battery according to various exemplary embodiments of the present invention. The cooling device according to the various exemplary embodiments in FIG. 3 and FIG. 4 includes a cooling fin 1 configured to receive heat generated by a plurality of battery cells C and to discharge the heat to the outside, a vehicle body panel 3, an extensible heat-transfer body 7 configured to receive the heat from the cooling fin 1, which is increased in length when the temperature increases and is decreased in length when the temperature decreases, and a restriction unit of supporting the extensible heat-transfer body 7 to increase the area in which the extensible heat-transfer body 7 comes into contact with the cooling fin 1 and the vehicle body panel 3 when the extensible heat-transfer body 7 is increased in length due to the heat transferred from the cooling fin 1.

The restriction unit includes support blocks 9, which are mounted between the cooling fin 1 and the vehicle body panel 3 to maintain a predetermined distance therebetween and to which both end portions of the extensible heat-transfer body 7 are secured.

The extensible heat-transfer body 7 is secured at both end portions thereof between the cooling fin 1 and the support blocks 9, and has a corrugated shape, which extends in the longitudinal direction between the cooling fin 1 and the vehicle body panel 3 in a zig-zag manner.

Since the extensible heat-transfer body 7 is constructed such that the contact area between the cooling fin 1 and the vehicle body panel 3 is reduced at a relatively low temperature and the contact area between the cooling fin 1 and the vehicle body panel 3 is increased at relatively high temperatures, the extensible heat-transfer body 7 comes into contact with the cooling fin 1 and the vehicle body panel 3 over a small area, and thus the heat transferred to the vehicle body panel 3 is reduced when a small amount of heat is transferred to the extensible heat-transfer body 7 because the temperature of the battery cells C is relatively low. Meanwhile, when a large amount of heat is transferred to the extensible heat-transfer body 7 because the temperature of the battery cells C is relatively high, the length of the extensible heat-transfer body 7 is increased and thus the bent portions of the extensible heat-transfer body 7 come into contact with the cooling fin 1 and with the vehicle body panel 3 over a relatively large area, whereby the heat is more effectively transferred to the vehicle body panel 3.

As will be appreciated from FIG. 3, when viewed in cross-section, the extensible heat-transfer body 7 is repeatedly bent in one direction three times and then in an opposite direction three times to define the corrugated shape. Each of the bent portions of the extensible heat-transfer body 7 is bent at a blunt angle.

As noted in FIG. 3, among the three bent portions of the extensible heat-transfer body 7, each of which is bent at a blunt angle, since the second bent portion is in linear contact with the cooling fin 1 or the vehicle body panel 3, it is possible to implement a state in which heat transfer from the cooling fin 1 to the vehicle body panel 3 is minimized. As illustrated in FIG. 4, when the length of the extensible heat-transfer body 7 is increased, the entire area between the two bent portions laterally adjacent to the second bent portion comes into surface-contact with the vehicle body panel 3, defining a heat-transfer surface. Consequently, it is possible to achieve more rapid and efficient heat transfer and high cooling performance.

The extensible heat-transfer body 7 may not be configured to have a locally bent shape but may be configured to have a corrugated shape, which is continuously curved. In the instant case, the contact area between the curved portion of the extensible heat-transfer body 7 and the cooling fin 1 and the vehicle body panel 3 decreases continuously as temperature decreases, and the contact area between the curved portion of the extensible heat-transfer body 7 and the cooling fin 1 and the vehicle body panel 3 increases continuously as the temperature increases.

The support blocks 9 may be made of wood or ceramic, which has a low coefficient of thermal expansion, such that the distance between the cooling fin 1 and the vehicle body panel 3 does not vary regardless of variation in temperature.

The extensible heat-transfer body 7 may be made of aluminum, iron-nickel alloy, iron, zinc, silver or the like, which has a high coefficient of thermal expansion and high thermal conductivity.

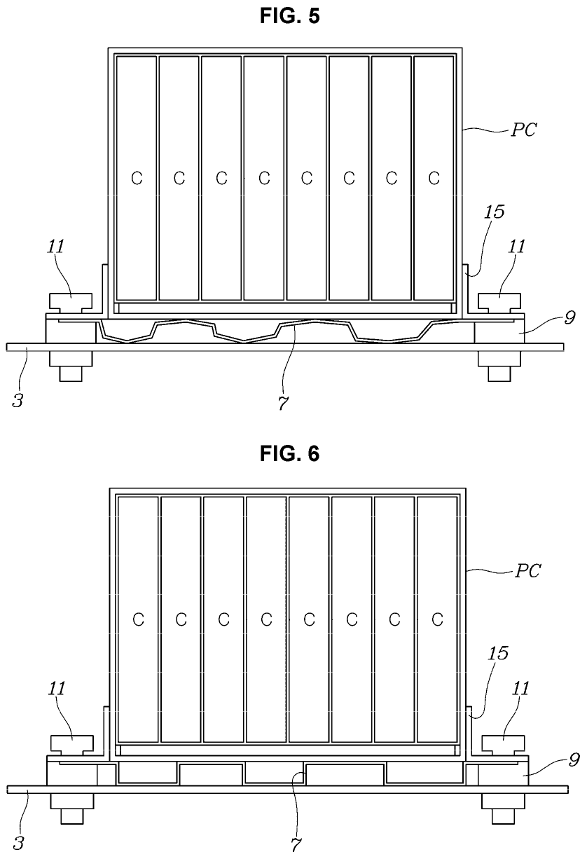

FIG. 5 and FIG. 6 are views illustrating various exemplary embodiments of the present invention. The components of the various exemplary embodiments in FIG. 5 and FIG. 6 are substantially the same as those of the various exemplary embodiments in FIG. 3 and FIG. 4 except for some of the components. The cooling device according to the various exemplary embodiments includes a module pack case PC, which surrounds a plurality of battery cells C to receive the heat generated by the battery cells C and to discharge the heat to the outside, a vehicle body panel 3 provided in a vehicle, an extensible heat-transfer body 7 configured to receive the heat from the module pack case PC, which is increased in length when the temperature increases, and a restriction unit of supporting the extensible heat-transfer body 7 to increase the area in which the extensible heat-transfer body 7 comes into contact with the module pack case PC and the vehicle body panel 3 when the extensible heat-transfer body 7 is increased in length due to the heat transferred from the module pack case PC.

The restriction unit includes support blocks 9, which are mounted between the cooling fin 1 and the vehicle body panel 3 to maintain a predetermined distance therebetween and to which both end portions of the extensible heat-transfer body 7 are secured, and fastening bolts 11 for fastening both end portions of the module pack case PC and both end portions of the extensible heat-transfer body 7 to the support blocks 9.

The extensible heat-transfer body 7 is secured at both end portions thereof between the module pack case PC and the support blocks 9 and has a corrugated shape, which extends in the longitudinal direction between the module pack case PC and the vehicle body panel 3 in a zig-zag manner.

In an exemplary embodiment of the present invention, a bracket 15 is mounted between the module pack case PC and the support blocks 9 and connected to the module pack case PC and fastened to the support blocks 9 via the fastening bolts 11.

For reference, the module pack case PC may be made of a material such as a steel material having a thickness of 1 mm, which has relatively high thermal conductivity and a relatively low coefficient of thermal expansion. When the extensible heat-transfer body 7 is made of a steel material having a thickness of 2 mm, the extensible heat-transfer body 7 may be made of, for example, an aluminum material having a thickness of 0.5 mm, which is less than the thickness of the material forming the module pack case PC or the vehicle body panel 3.

Since the function of controlling cooling performance according to the various exemplary embodiments in FIG. 5 and FIG. 6 is the same as that of the various exemplary embodiments of the present invention in FIG. 3 and FIG. 4, a description thereof will be omitted.

As is apparent from the above description, various aspects of the present invention are directed to providing a cooling device configured for a vehicle battery, which is configured to actively cool the battery without consuming power and to achieve minimization of cooling performance at a low temperature and enhancement of cooling performance at a high temperature, whereby it is possible to efficiently cool the vehicle battery at a low cost.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A cooling device for a vehicle battery, the cooling device including:
a cooling fin receiving heat generated by a plurality of battery cells and discharging the heat to an outside of the cooling fin; and
a bendable heat-transfer body receiving heat from the cooling fin, the bendable heat-transfer body being composed of a bimetal so that the bimetal is spaced from a vehicle body panel when a temperature decreases and so that the bimetal is bent to be brought into contact with the vehicle body panel when the temperature increases.

2. The cooling device according to claim 1, wherein a first end portion and a second end portion of the bendable heat-transfer body are secured to the cooling fin and an intermediate portion of the bendable heat-transfer body is brought into contact with the vehicle body panel when the bendable heat-transfer body is deformed due to the heat transferred from the cooling fin.

3. A cooling device for a vehicle battery, the cooling device comprising:
a cooling fin receiving heat generated by a plurality of battery cells and discharging the heat to an outside of the cooling fin;
a vehicle body panel mounted in a vehicle;
an extensible heat-transfer body receiving the heat from the cooling fin, wherein a length of the extensible heat-transfer body is increased when a temperature increases and is decreased when the temperature decreases; and
a restriction unit of supporting the extensible heat-transfer body to increase an area in which the extensible heat-transfer body comes into contact with the cooling fin and the vehicle body panel when the length of the extensible heat-transfer body is increased due to the heat transferred from the cooling fin.

4. The cooling device according to claim 3, wherein the restriction unit includes support blocks, which are mounted between the cooling fin and the vehicle body panel to maintain a predetermined distance between the cooling fin and the vehicle body panel and to which a first end portion and a second end portion of the extensible heat-transfer body are secured.

5. The cooling device according to claim 4, wherein the extensible heat-transfer body is secured at the first end portion and the second end portion of the extensible heat-transfer body between the cooling fin and the support blocks.

6. The cooling device according to claim 5, wherein the extensible heat-transfer body has a corrugated shape, which extends in a longitudinal direction between the cooling fin and the vehicle body panel in a zig-zag manner.

7. The cooling device according to claim 6, wherein the extensible heat-transfer body is constructed such that a contact area between the cooling fin and the vehicle body panel is reduced when a temperature of the extensible heat-transfer body is decreased and the contact area between the cooling fin and the vehicle body panel is increased when the temperature of the extensible heat-transfer body is increased.

8. The cooling device according to claim 6, wherein the extensible heat-transfer body is repeatedly bent in one direction three times and then in an opposite direction three times to define the corrugated shape, and each of bent portions of the extensible heat-transfer body is bent at a blunt angle.

9. The cooling device according to claim 4, wherein the support blocks are made of wood or ceramic.

10. A cooling device for a vehicle battery, the cooling device comprising:
a module pack case, which surrounds a plurality of battery cells to receive heat generated by the plurality of battery cells and discharging the heat to an outside of the module pack case;
an extensible heat-transfer body receiving the heat from the module pack case, a length of which is increased when a temperature increases and is decreased when the temperature decreases; and
a restriction unit of supporting the extensible heat-transfer body to increase an area in which the extensible heat-transfer body comes into contact with the module pack case and a vehicle body panel when the length of the extensible heat-transfer body is increased due to the heat transferred from the module pack case.

11. The cooling device according to claim 10, wherein the restriction unit includes:
support blocks, which are mounted between the cooling fin and the vehicle body panel to maintain a predetermined distance between the cooling fin and the vehicle body panel, and to which a first end portion and a second end portion of the extensible heat-transfer body are secured; and
fasteners for fastening a first end portion and a second end portion of the module pack case and the first end portion and the second end portion of the extensible heat-transfer body to the support blocks.

12. The cooling device according to claim 11, wherein the extensible heat-transfer body is secured at the first end portion and the second end portion of the extensible heat-transfer body between the module pack case and the support blocks.

13. The cooling device according to claim 12, wherein the extensible heat-transfer body has a corrugated shape, which extends in a longitudinal direction between the module pack case and the vehicle body panel in a zig-zag manner.

14. The cooling device according to claim 13, wherein the extensible heat-transfer body is repeatedly bent in one direction three times and then in an opposite direction three times to define the corrugated shape, and each of bent portions of the extensible heat-transfer body is bent at a blunt angle.

15. The cooling device according to claim 11, further includes brackets mounted between the module pack case and the support blocks, wherein the fasteners are configured for fastening the module pack case and the brackets to the support blocks.

16. The cooling device according to claim 1, wherein the bimetal includes one of iron-nickel alloy and iron, which is a first metal having a coefficient of thermal expansion higher than a predetermined coefficient, and one of nickel-chrome-iron alloy, copper-zinc alloy and copper, which is a second metal having a coefficient of thermal expansion lower than the predetermined coefficient, the first and second metals being layered and integrally formed with each other.

17. The cooling device according to claim 3, wherein the extensible heat-transfer body is made of one of aluminum, iron-nickel alloy, iron, zinc and silver.

18. The cooling device according to claim 10, wherein the extensible heat-transfer body is made of one of aluminum, iron-nickel alloy, iron, zinc and silver.
